(19) United States
(12) Patent Application Publication
(10) Pub. No.: US 2004/0208685 A1
(43) Pub. Date: Oct. 21, 2004

(54) Ring binder having an exterior shield

(75) Inventor: John E. Peters, JR., Lake Forest, IL (US)

Correspondence Address: MICHAEL BEST & FRIEDRICH, LLP, 100 E WISCONSIN AVENUE, MILWAUKEE, WI, 53202, US

(73) Assignee: ACCO Brands, Inc., Lincolnshire, IL (US)

(21) Appl. No.: 10/822,418

(22) Filed: Apr. 12, 2004

Related U.S. Application Data
(60) Provisional application No. 60/464,267, filed on Apr. 21, 2003.

(51) Int. Cl. B42F 13/00

(52) U.S. Cl. 402/73

(57) ABSTRACT

The invention provides a shield for use on at least a portion of the exterior of a ring binder. The shield can have a hardness greater than the underlying panel of the binder. In some embodiments, at least a portion of a ring mechanism is mounted on an exterior side of the binder to act as the shield. For example, the chassis of the ring mechanism can be mounted on an exterior surface of the binder while at least one ring extends through an aperture in the binder to the interior side of the binder. Particularly, the chassis can be coupled to a mounting surface on the exterior surface of the binder's spine panel.

### RELATED APPLICATIONS

This application claims priority to U.S. Provisional Patent Application No. 60/464,267, filed Apr. 21, 2003. The contents of Application No. 60/464,267 are hereby incorporated by reference.

### FIELD OF THE INVENTION

The invention relates to binders, and more particularly to ring binders.

### BACKGROUND OF THE INVENTION

The support panels of a conventional ring binder, which are sometimes referred to collectively as a flat, are typically constructed of plastic, cardboard, or cardboard wrapped with vinyl. The flat typically includes a front panel, a rear panel, and a spine panel connecting the front panel to the rear panel either directly or via hinges formed by vinyl wrapping. Conventional ring binders also employ a ring mechanism mounted on the interior of the flat to allow a user to insert documents into the binder and securely store them. The ring mechanism typically includes a chassis, a ring actuator positioned in the chassis, and one or more rings coupled to the actuator.

The chassis of the ring mechanism is mounted on an interior surface of the flat and is typically an elongated piece of metal defining a curved shroud that terminates in opposing curled lateral edges abutting the interior surface of the flat. The ring actuator (e.g., typically consisting of one or two hinge blades) is positioned in the chassis, and the rings are attached to the actuator. The rings extend into the interior of the binder through one or more apertures in the shroud of the chassis.

### SUMMARY OF THE INVENTION

The present invention provides a shield, and more preferably a hardened shield on at least a portion of the exterior surface of a ring binder. In one embodiment the shield is located on the exterior surface of the binder's flat (e.g., on the spine panel) and is defined by the chassis of a ring mechanism. The chassis, which is typically made from a metal (e.g., spring steel) or a hard plastic material, provides a hardened exterior surface on the flat, and more specifically, on the spine of the binder. The shield can cover at least 50%, preferably 75%, and more preferably 90% of the surface of the spine. Preferably, the chassis is curved to make the binder easier to grasp and hold than traditional planar spine configurations. Furthermore, using a metallic chassis to define a portion of the spine's exterior provides a unique and aesthetically pleasing look when compared to typical casebound binders, molded binders, or vinyl binders.

In one embodiment, the spine panel defines an aperture extending through the spine panel, and the ring mechanism includes a ring and/or trigger lever extending through the aperture into the interior of the binder.

The chassis can have a substantially continuous, longitudinally-extending surface terminating in two spaced-apart, longitudinally-extending edges. The space between the edges defines an elongated opening in the chassis. A ring actuator (e.g., hinge blades) is positioned within the chassis, and the rings are coupled to the actuator.

Further aspects of the present invention, together with the organization and operation thereof, will become apparent from the following detailed description of the invention when taken in conjunction with the accompanying drawings, wherein like elements have like numerals throughout the drawings.

### BRIEF DESCRIPTION OF THE DRAWINGS

The present invention is further described with reference to the accompanying drawings, which illustrate certain embodiments of the present invention. It is to be understood that the invention is not limited in its application or construction to the details of construction and the arrangements of the components set forth in the following description or illustrated in the drawings. Rather, the invention disclosed in the accompanying drawings is illustrated by way of example only. Also, it is understood that the phraseology and terminology used herein is for the purpose of description and should not be regarded as limiting. The various elements and combinations of elements described below and illustrated in the drawings can be arranged and organized differently to result in embodiments which are still within the spirit and scope of the present invention.

In the drawings, wherein like reference numerals indicate like parts:

FIG. 1 is a perspective view of one embodiment of a ring binder embodying the present invention;

FIG. 2 is an exploded perspective view of the ring binder illustrated in FIG. 1;

FIG. 3 is a section view taken along line 3-3 of FIG. 1;

FIG. 4 is an enlarged perspective view, partially in section, of the ring binder illustrated in FIG. 1 with the panels of the ring binder in an open position;

FIG. 5 is a perspective view of an alternative embodiment of a ring binder embodying the invention; and

FIG. 6 is a perspective view of yet another alternative embodiment of a ring binder embodying the invention.

### DETAILED DESCRIPTION

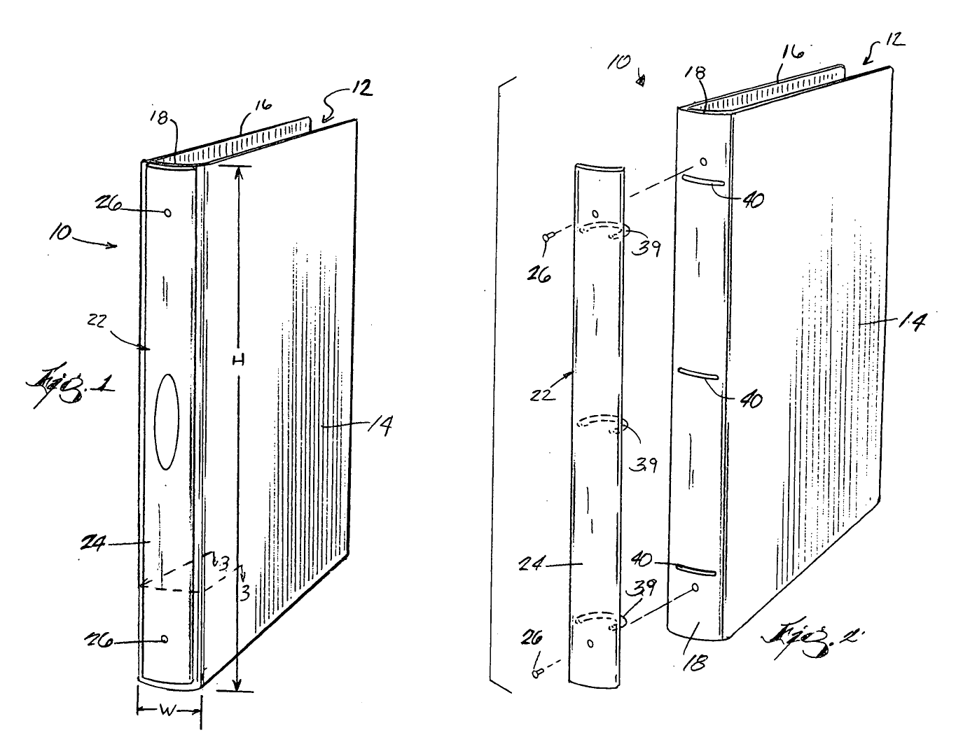

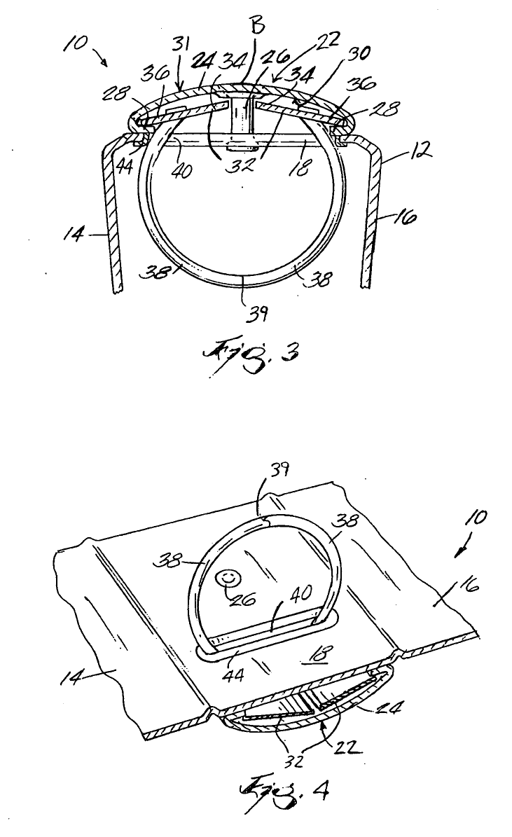

FIGS. 1-4 illustrate a ring binder 10 embodying the present invention. The ring binder 10 includes a flat 12 having a front panel 14, a rear panel 16, and a spine panel 18 interconnecting the front and rear panels 14, 16. The flat 12 can be made of a variety of materials that are well known in the art. For example, the flat 12 can be made of cardboard, plastic, cardboard wrapped in vinyl, and the like. By way of example only, the illustrated flat 12 is cardboard of the type used in what is typically referred to as a casebound binder.

The binder 10 includes a shield defining an exterior surface of the binder's spine. In the illustrated embodiment, the shield is defined by a portion of a ring mechanism 22, and more specifically by a chassis 24 of the ring mechanism 22. However, those skilled in the art will understand that the shield of the binder 10 need not be formed by the ring mechanism 22, but rather can be a separate component secured to the binder to define a portion of the flat's exterior surface (see, e.g., FIG. 6 and related discussion below).

The ring mechanism 22 illustrated in FIGS. 1-4 includes components that are similar to typical prior art ring mechanisms. However, the components of the ring mechanism 22 are configured differently from prior art ring mechanisms. The ring mechanism 22 includes the chassis 24, a ring actuator in the form of hinge blades 32 positioned in the chassis 24, and one or more ring halves 38 that cooperate to define rings 39. While three rings 39 are shown in the illustrated embodiment, fewer or more rings can be used.

As best seen in FIG. 3, the illustrated chassis 24 is made of metal and has spaced-apart crimped or bent edges 28. A body portion B of the chassis 24 extends between the edges 28 and is curved in a cross-section taken perpendicular to the longitudinal axis of the chassis 24. The body portion B of the chassis 24 defines an interior concave surface 30 and an exterior convex surface 31.

The chassis 24 can be made of substantially any material, such as metals, plastics, and the like. In the illustrated embodiment, the chassis 24 is made of steel, which is substantially harder than the cardboard material of the flat 12. The chassis 24 can also have a variety of finishes, textures, colors, and surface treatments. For example, the chassis 24 could be wrapped in cloth, fabric, vinyl, or coated with plastic, rubber, resin, paint, and the like. Different metallic finishes, such as polished chrome, brushed chrome, brushed nickel, polished brass, polished bronze, and the like can also be used. The chassis 24 can include various patterns of ribs, dimples, protrusions, and the like as well. The finish, texture, color, and surface treatments of the chassis 24 can be selected to facilitate grasping and holding the binder 10, to increase the durability and strength of the binder 10, to provide an organizational or differentiating system for a plurality of binders 10, and/or to achieve the desired aesthetic characteristics of the binder 10.

Those skilled in the art will also understand that the specific shape of the chassis 24 can be modified from that shown in the figures. For example, while the illustrated chassis 24 is elongated along a longitudinal axis and curved about that axis, the chassis of other embodiments can have substantially any suitable cross-sectional shape, provided it remains suited for operation as part of the ring mechanism 22. For example, the shape can be two or three dimensional, such as substantially flat, triangular, bowed or arched about one or more axes, boxed (or other multisided shape), rippled, crimped, dimpled, and the like. Furthermore, although the illustrated chassis 24 has a substantially rectangular perimeter as viewed in FIG. 1, the chassis of other embodiments can have substantially any perimeter shape. For example, the perimeter can be oval-shaped, polygonal-shaped (e.g., diamond-shaped), or irregularly-shaped (e.g., wavy, jagged, etc.).

As noted above, the illustrated ring actuator includes one or more hinge blades 32 housed within the chassis 24. As shown in FIG. 3, two hinge blades 32 are positioned within the chassis 24. The structure and operation of the illustrated hinge blades 32 is well understood in the art. Each hinge blade 32 has an inner end 34 and an outer end 36. The hinge blades 32 are coupled to the chassis 24 such that the crimped edges 28 of the chassis 24 retain the respective outer ends 36 of the hinge blades 32. As the ring mechanism 22 is opened and closed, the hinge blades 32 pivot about their respective outer ends 36 such that the inner ends 34 move toward or away from the interior surface 30 of the chassis 24. One of ordinary skill in the art would understand that in alternative embodiments, the ring mechanism 22 may include only one movable hinge blade 32, or may operate using other know ring actuators.

Still referring to FIG. 3, each ring half 38 is mounted to a respective hinge blade 32 to open and close the rings 39 upon actuation of the hinge blades 32. In the embodiment illustrated in FIGS. 1-4, the hinge blades 32 are actuated by manually opening and closing the rings 39. Unlike prior art ring mechanisms, each ring half 38 extends away from the interior surface 30 of the chassis 24 and does not extend through the body portion B of the chassis 24. Rather, the ring halves 38 extend out of the chassis 24 through the elongated opening defined between the edges 28. Thus, the ring mechanism 22, and more specifically the orientation of the ring halves 38, is reversed from prior art ring mechanisms, where the ring halves extend away from the chassis edges and through openings formed in the body portion of the chassis.

As best shown in FIG. 3, the ring mechanism 22 is mounted on the spine panel 18 such that the crimped edges 28 of the chassis 24 engage the exterior surface of the spine panel 18, and the body portion B of the chassis 24 extends from the exterior surface of the spine panel 18. As such, the combination of the chassis 24 and the spine panel 18 form the overall exterior spine surface of the binder 10. The spine panel 18 encloses the chassis 24, thereby retaining the hinge blades 32 inside the chassis 24 and protecting the user from the movement of the hinge blades 32. Although the chassis 24 is described and illustrated as being located on the exterior surface of the spine panel 18, the chassis 24 could alternatively be located on the exterior surface of the front panel 14 or the rear panel 16.

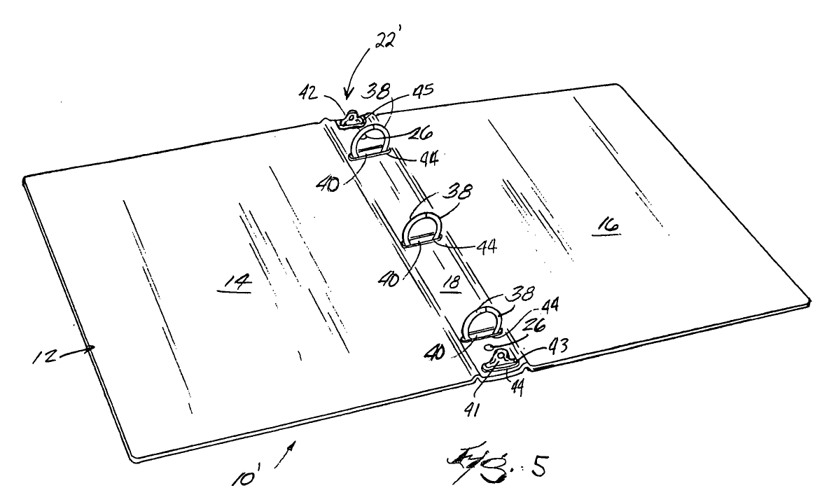

The spine panel 18 includes a plurality of apertures 40 in the form of slots configured to receive the respective rings 39. As the ring mechanism 22 is being mounted on the spine panel 18, the rings 39 are aligned with the respective apertures 40 and inserted through the apertures 40, thereby passing from the exterior of the binder 10 into the interior of the binder 10. As illustrated in FIGS. 3 and 4, the periphery of each aperture 40 is defined by a grommet 44. The grommets 44 can be made of metal, plastic, resin, composites, rubber, and the like. The grommets 44 reinforce the apertures 40 and provide a finished, aesthetically-pleasing look to the binder 10.

Fasteners 26 in the form of rivets or other suitable mounting members (e.g., screws, bolts, adhesives, and the like) are used to mount the mounting mechanism 22 to the spine panel 18. Alternatively, if the flat is made of molded plastic, an integral plastic post can be used to locate the ring mechanism 22, and once located, the end of the plastic post can be deformed to secure the ring mechanism 22 to the binder.

In the illustrated embodiment, the chassis 24 covers a majority of the exterior surface of the spine panel 18. More specifically, the chassis 24 covers both the majority of the height H and the width W of the spine panel 18. It should be appreciated, however, that the chassis 24 could cover more or less of the height H and width W of the spine panel. In the illustrated embodiment, the chassis 24 is about 90% to 100%, and more preferably about 95% to 98%, of the height H of the spine panel 18. Furthermore, the chassis 24 is about 70% to 100%, and more preferably about 80% to 90%, of the width W of the spine panel 18.

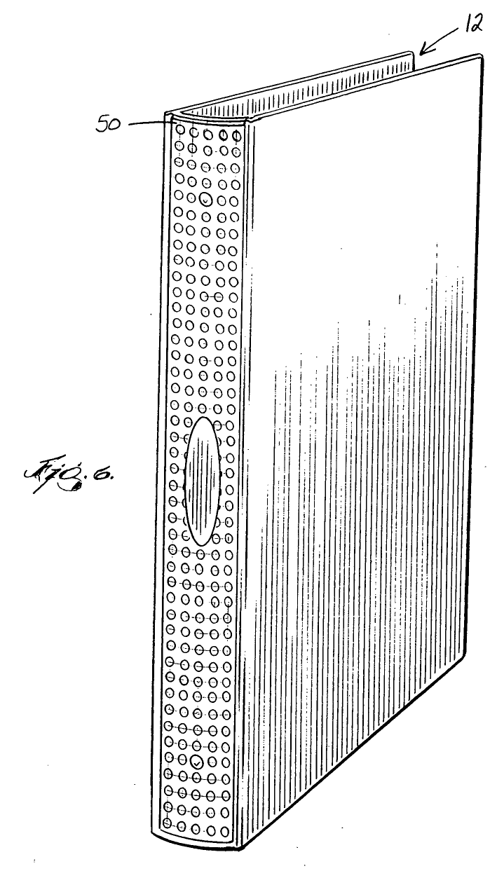

FIG. 5 illustrates an alternative embodiment of a ring binder 10′ that is substantially the same as the ring binder 10, with the following exceptions. Like parts have been given like reference numerals. The rings 39 of the ring mechanism 22′ are opened and closed either by manual actuation of the ring halves 38, or by using trigger levers 41 and 42. Like the rings 39, the trigger levers 41, 42 are also reversed from the normal orientation on prior art ring mechanisms. Specifically, the trigger levers 41, 42 extend away from the body portion B of the chassis 24 without ever passing through or around the exterior surface 31.

The first trigger lever 41 is shown extending through an aperture in the form of a slot 43 located a short distance from the bottom edge of the spine panel 18, in much the same manner as the rings 39 extend through the apertures 40. A grommet 44 can be used to line the slot 43. The second trigger lever 42, located near the top edge of the spine panel 18, is shown extending through an aperture in the form of a notch 45 formed in the top end of the spine panel 18. Either of these arrangements can also be used separately on any given binder 10′. Other alternatives for trigger lever positioning are also contemplated. For example, the trigger levers could extend completely around the outer edge of the spine panel 18, or the trigger levers could be positioned on the exterior of the binder 10′.

While two specific embodiments of the present invention are illustrated and described above, it is understood that other configurations of the present invention could be used without deviating from the spirit of the present invention. For example, the ring mechanism 22 could interconnect the front and rear panels 14, 16 without requiring any spine panel 18. In such an embodiment, the ring mechanism 22 could be coupled directly to one edge of each of the front panel 14 and the rear panel 16 to form the spine of the binder. The connecting edges of the front panel 14 and the rear panel 16 could be directly bonded, crimped, pressed, or hinged to a portion or edge of the chassis 24.

In such an embodiment, the ring mechanism 22 would be modified to enclose the chassis 24, thereby preventing the hinge blades 32 from falling out of the chassis 24 and protecting the user from the moving components, i.e., the hinge blades 32, of the ring mechanism. For example, the edges 28 of the chassis 24 could be extended toward each other to form a wall that can close or substantially close the chassis 24 and form a housing for the hinge blades 32. Alternatively, an additional plate can be positioned between the edges 28 of the chassis 24 to close the chassis 24 and form a suitable housing.

Finally, it should also be understood that while the shield on the exterior surface of the binder 10 is defined by the chassis 24 of the ring mechanism 22, other binders may achieve the benefits of an exterior shield without using the ring mechanism 22 to define the shield. Instead, a separate piece of material 50, which can be made from the same materials and can have the same shape, size, finishes, textures, and surface treatments discussed above, can be secured to the exterior surface of the flat 12 (see FIG. 6) to achieve the desired advantageous characteristics described above. The separate shield piece 50 may or may not be harder than the material used for the flat 12.

Various features of the invention are set forth in the following claims.

I claim:

1. A binder comprising:
a first panel;
a second panel; and
a ring mechanism between the first and second panels, the ring mechanism at least partially defining a spine that interconnects the first and second panels and that defines an interior spine surface and an exterior spine surface, the ring mechanism at least partially defining a portion of the exterior spine surface.

2. The binder of claim 1, wherein the portion of the exterior spine surface defined by the ring mechanism is metallic.

3. The binder of claim 1, wherein the ring mechanism defines a longitudinal axis, and wherein the portion of the exterior spine surface defined by the ring mechanism is curved in a cross-section taken substantially perpendicular to the longitudinal axis.

4. The binder of claim 1, wherein the ring mechanism includes a chassis configured to house a moving component of the ring mechanism, and wherein the chassis defines a portion of the exterior spine surface.

5. The binder of claim 1, wherein the spine is further defined by a spine panel connecting the first and second panels, and wherein the ring mechanism is connected to the spine panel.

6. The binder of claim 5, wherein the spine panel includes an interior surface and an exterior surface, and wherein the ring mechanism is mounted to the exterior surface of the spine panel.

7. The binder of claim 6, wherein the spine panel defines an aperture extending between the interior surface and the exterior surface, and wherein the ring mechanism includes a ring extending through the aperture.

8. The binder of claim 6, wherein the spine panel defines an aperture extending between the interior surface and the exterior surface, and wherein the ring mechanism includes a trigger extending through the aperture.

9. The binder of claim 5, wherein the spine panel includes an end having a notch formed therein, and wherein the ring mechanism includes a trigger extending through the notch.

10. A binder comprising:
a first panel;
a second panel;
a spine panel connecting the first and second panels, the spine panel having an exterior surface and being made of a first material having a hardness; and
a hardened shield mounted on the exterior surface and being made of a second material having a hardness greater than the hardness of the first material.

11. The binder of claim 10, wherein the spine panel has a height in the longitudinal direction of the binder mechanism and the shield extends more than 20% of the height of the spine panel.

12. The binder of claim 10, wherein the spine panel has a height in the longitudinal direction of the binder mechanism and the shield extends more than 50% of the height of the spine panel.

13. The binder of claim 10, wherein the spine panel has a height in the longitudinal direction of the binder mechanism and the shield extends more than 75% of the height of the spine panel.

14. The binder of claim 10, further comprising a ring mechanism, wherein the hardened shield comprises a ring mechanism chassis.

15. The binder of claim 14, wherein the spine panel defines an aperture, and wherein the ring mechanism includes a ring extending through the aperture.

16. The binder of claim 14, wherein the ring mechanism is metallic.

17. The binder of claim 14, wherein the ring mechanism includes a chassis that defines an exterior spine surface extending from the exterior surface of the spine panel.

18. The binder of claim 17, wherein the ring mechanism defines a longitudinal axis, and wherein the chassis is curved in a cross-section taken substantially perpendicular to the longitudinal axis.

19. A binder comprising:
a first panel;
a second panel;
a spine panel connecting the first and second panels and having an opening through the spine panel; and
a ring mechanism mounted to the spine panel and having a ring positioned through the opening.

20. The binder of claim 19, wherein the ring mechanism is mounted on an exterior surface of spine panel.

21. The binder of claim 19, wherein the spine panel includes three openings and the ring mechanism includes three rings, each ring being positioned through an opening.

22. The binder of claim 19, wherein the ring mechanism includes two hinge blades.

23. A ring mechanism comprising:
a chassis having a substantially continuous longitudinally-extending surface and two longitudinally-extending edges connected to the surface and defining an opening;
a ring actuator positioned within the chassis between the two edges; and
a ring coupled to the actuator and extending through the opening away from the surface.

24. The ring mechanism of claim 23, wherein the ring actuator comprises two hinge blades.

25. The ring mechanism of claim 24, wherein each hinge blade engages a respective one of the edges.

26. The ring mechanism of claim 23, further comprising three rings.

27. The ring mechanism of claim 23, wherein the chassis defines a longitudinal axis, and wherein the surface is curved in a cross-section taken substantially perpendicular to the longitudinal axis.
